(19) United States
(12) Patent Application Publication
(10) Pub. No.: US 2026/0080517 A1
(43) Pub. Date: Mar. 19, 2026

(54) DATA PROCESSING METHOD AND APPARATUS

(71) Applicant: HUAWEI TECHNOLOGIES CO., LTD., Shenzhen (CN)

(72) Inventors: Enze Xie, Shenzhen (CN); Kai Chen, Shenzhen (CN); Lanqing Hong, Hong Kong (CN); Zhenguo Li, Shenzhen (CN)

(73) Assignee: HUAWEI TECHNOLOGIES CO., LTD., Shenzhen (CN)

(21) Appl. No.: 19/399,928

(22) Filed: Nov. 25, 2025

Related U.S. Application Data
(63) Continuation of application No. PCT/CN2024/094632, filed on May 22, 2024.

(30) Foreign Application Priority Data
May 26, 2023 (CN) 202310612909.1

(51) Int. Cl. G06T 5/70; G06T 5/60

(52) U.S. Cl. CPC G06T 5/70; G06T 5/60; G06T 2207/20081; G06T 2207/20084

(57) ABSTRACT

A data processing method, which is applied to the artificial intelligence field, includes: obtaining a first image and text information, where the text information indicates a location constraint of at least one object in an image, and the first image is an image obtained by performing noise addition using a noise addition module in a diffusion model; processing the text information based on a text encoder to obtain a first feature representation; and obtaining a second image based on a fusion result of the first image and the first feature representation by using a denoising model in the diffusion model, where an object included in the second image meets the location constraint indicated by the text information.

### CROSS-REFERENCE TO RELATED APPLICATIONS

This application is a continuation of International Application No. PCT/CN2024/094632, filed on May 22, 2024, which claims priority to Chinese Patent Application No. 202310612909.1, filed on May 26, 2023. The disclosures of the aforementioned applications are hereby incorporated by reference in their entireties.

### TECHNICAL FIELD

This disclosure relates to the artificial intelligence field, and in particular, to a data processing method and apparatus.

### BACKGROUND

Artificial intelligence (AI) is a theory, a method, a technology, or an application system that simulates, extends, and expands human intelligence by using digital computers or machines controlled by digital computers, to perceive environments, obtain knowledge, and achieve optimal results based on the knowledge. In other words, AI is a branch of computer science that seeks to understand the essence of intelligence and to create a new kind of intelligent machine able to respond in ways similar to human intelligence. AI research focuses on design principles and implementation methods of various intelligent machines, to enable the machines possess the functions of perception, inference, and decision-making.

In recent years, diffusion models have made significant progress and gained considerable attention in the generative field. Although probabilistic diffusion models have shown outstanding performance in content creation and have become some of the most popular generative models, they have some limitations in the application to data generation of perception tasks (such as object detection). Specifically, in data generation of complex perception tasks such as object detection and pose estimation, fine-grained geometric control, for example, control of a bounding box location, is required. However, existing diffusion models are not ideal in this regard, and struggle to accurately control geometric constraints of objects in generated images.

### SUMMARY

This disclosure provides a data processing method, to obtain a more accurate image that meets a geometric constraint.

According to a first aspect, this disclosure provides a data processing method. The method includes: obtaining a first image and text information, where the text information indicates a location constraint of at least one object in an image, and the first image is an image obtained by performing noise addition using a noise addition module in a diffusion model; processing the text information based on a text encoder to obtain a first feature representation; and obtaining a second image based on a fusion result of the first image and the first feature representation by using a denoising model in the diffusion model, where an object included in the second image meets the location constraint indicated by the text information.

In this embodiment of this disclosure, a feature representation of text information indicating a location constraint of an object in a generated image and the image are input into an image generator together. Compared with a conventional technology in which only the first image is used as an input of the image generator, in this disclosure, the image generator can more accurately obtain an image that meets a geometric constraint specified in the text information.

In addition, transferability of the text encoder is used, so that a specific conditional encoding network module does not need to be designed for a specific geometric condition, and therefore an entire framework has strong flexibility and scalability.

In an embodiment, the first image is an image obtained by performing noise addition on an original image using the noise addition module in the diffusion model, the original image includes the at least one object, and the text information specifically includes a size of a detection box corresponding to each object in the original image and a location of the detection box in the original image.

In an embodiment, the text information further includes: a category of image content in the detection box, or camera viewpoint information present when the first image is captured. In an embodiment, the object is a key point on a person for indicating a pose.

In an embodiment, the fusion result is obtained by performing attention mechanism-based interaction on the first image and the first feature representation.

According to a second aspect, this disclosure provides a data processing method. The method includes: obtaining a first image and text information, where the text information indicates a location constraint of at least one object in an image, and the first image is an image obtained by performing noise addition on an original image using a noise addition module in a diffusion model; processing the text information based on a text encoder to obtain a first feature representation; obtaining a second image based on a fusion result of the first image and the first feature representation using an image generator in the diffusion model; and determining a loss based on the second image and the original image, and updating the text encoder and a denoising model based on the loss.

In an embodiment, the at least one object is located in a foreground region in the second image; and the determining the loss based on the second image and the original image includes: determining a first loss based on the foreground region of the second image and a foreground region of the original image; determining a second loss based on a background region of the second image and a background region of the original image; and fusing the first loss and the second loss through weighting to obtain the loss, where a weight corresponding to the first loss is greater than a weight corresponding to the second loss.

In an embodiment, to alleviate an imbalance problem of a foreground region in a generated image, values of a loss corresponding to the foreground region and a loss corresponding to a background region may be controlled in a training process, to help the model pay more attention to generation of a foreground object, thereby improving generation effect of the foreground region.

In an embodiment, the at least one object includes a first object and a second object; the first object is located in a first foreground region in the second image, and the second object is located in a second foreground region in the second image; and the determining the loss based on the second image and the original image includes: determining a first sub-loss based on the first foreground region and a foreground region that is in the original image and that corresponds to the first foreground region; determining a second sub-loss based on the second foreground region and a foreground region that is in the original image and that corresponds to the second foreground region; and fusing the first sub-loss and the second sub-loss through weighting to obtain the first loss, where the first loss is a part of the loss, an area of the first foreground region is greater than that of the second foreground region, and a weight corresponding to the first sub-loss is less than a weight corresponding to the second foreground region.

In an embodiment, to alleviate an imbalance problem of the foreground region in the generated image, values of a loss corresponding to a small-area object (or referred to as a small object) in the foreground region and a loss corresponding to a large-area object in the foreground region may be controlled in the training process, to improve generation effect of the small-area object.

In an embodiment, the first image is the image obtained by performing noise addition on the original image using the noise addition module in the diffusion model, the original image includes the at least one object, and the text information specifically includes a size of a detection box corresponding to each object in the original image and a location of the detection box in the original image.

In an embodiment, the text information further includes: a category of image content in the detection box, or camera viewpoint information present when the first image is captured.

In an embodiment, the object is a key point on a person for indicating a pose.

In an embodiment, the fusion result is obtained by performing attention mechanism-based interaction on the first image and the first feature representation.

According to a third aspect, this disclosure provides a data processing apparatus. The apparatus includes:
an obtaining module, configured to obtain a first image and text information, where the text information indicates a location constraint of at least one object in an image, and the first image is an image obtained by performing noise addition using a noise addition module in a diffusion model; and
a processing module, configured to: process the text information based on a text encoder to obtain a first feature representation; and
obtain a second image based on a fusion result of the first image and the first feature representation by using a denoising model in the diffusion model, where an object included in the second image meets the location constraint indicated by the text information.

In an embodiment, the first image is an image obtained by performing noise addition on an original image using the noise addition module in the diffusion model, the original image includes the at least one object, and the text information specifically includes a size of a detection box corresponding to each object in the original image and a location of the detection box in the original image.

In an embodiment, the text information further includes: a category of image content in the detection box, or camera viewpoint information present when the first image is captured.

In an embodiment, the object is a key point on a person for indicating a pose.

In an embodiment, the fusion result is obtained by performing attention mechanism-based interaction on the first image and the first feature representation.

According to a fourth aspect, this disclosure provides a data processing apparatus. The apparatus includes:
an obtaining module, configured to obtain a first image and text information, where the text information indicates a location constraint of at least one object in an image, and the first image is an image obtained by performing noise addition on an original image using a noise addition module in a diffusion model; and
a processing module, configured to: process the text information based on a text encoder to obtain a first feature representation;
obtain a second image based on a fusion result of the first image and the first feature representation using an image generator in the diffusion model; and
determine a loss based on the second image and the original image, and update the text encoder and a denoising model based on the loss.

In an embodiment, the processing module is specifically configured to:
determine a first loss based on a foreground region of the second image and a foreground region of the original image;
determine a second loss based on a background region of the second image and a background region of the original image; and
fuse the first loss and the second loss through weighting to obtain the loss, where a weight corresponding to the first loss is greater than a weight corresponding to the second loss.

In an embodiment, the at least one object includes a first object and a second object; the first object is located in a first foreground region in the second image, and the second object is located in a second foreground region in the second image; and the processing module is specifically configured to:
determine a first sub-loss based on the first foreground region and a foreground region that is in the original image and that corresponds to the first foreground region;
determine a second sub-loss based on the second foreground region and a foreground region that is in the original image and that corresponds to the second foreground region; and
fuse the first sub-loss and the second sub-loss through weighting to obtain the first loss, where the first loss is a part of the loss, an area of the first foreground region is greater than that of the second foreground region, and a weight corresponding to the first sub-loss is less than a weight corresponding to the second foreground region.

In an embodiment, the first image is the image obtained by performing noise addition on the original image using the noise addition module in the diffusion model, the original image includes the at least one object, and the text information specifically includes a size of a detection box corresponding to each object in the original image and a location of the detection box in the original image.

In an embodiment, the text information further includes: a category of image content in the detection box, or camera viewpoint information present when the first image is captured.

In an embodiment, the object is a key point on a person for indicating a pose.

In an embodiment, the fusion result is obtained by performing attention mechanism-based interaction on the first image and the first feature representation.

According to a fifth aspect, an embodiment of this disclosure provides a training apparatus. The apparatus may include a memory, a processor, and a bus system. The memory is configured to store a program, and the processor is configured to execute the program in the memory, to perform the method according to any one of the first aspect and the optional embodiments of the second aspect.

According to a sixth aspect, an embodiment of this disclosure provides an execution apparatus. The apparatus may include a memory, a processor, and a bus system. The memory is configured to store a program, and the processor is configured to execute the program in the memory, to perform the method according to any one of the second aspect and the optional embodiments of the first aspect.

According to a seventh aspect, an embodiment of this disclosure provides a computer-readable storage medium. The computer-readable storage medium stores a computer program. When the computer program is run on a computer, the computer is caused to perform the method according to any one of the first aspect and the optional embodiments of the first aspect and the method according to any one of the second aspect and the optional embodiments of the second aspect.

According to an eighth aspect, an embodiment of this disclosure provides a computer program. When the computer program is run on a computer, the computer is caused to perform the method according to any one of the first aspect and the optional embodiments of the first aspect and the method according to any one of the second aspect and the optional embodiments of the second aspect.

According to a ninth aspect, this disclosure provides a chip system. The chip system includes a processor, configured to support a data processing apparatus in implementing functions in the foregoing aspects, for example, sending or processing data or information in the foregoing methods. In a possible design, the chip system further includes a memory. The memory is configured to store program instructions and data that are necessary for an execution device or a training device. The chip system may include a chip, or may include a chip and another discrete component.

### BRIEF DESCRIPTION OF DRAWINGS

FIG. 1A is a diagram of a structure of a main framework of artificial intelligence according to some embodiments of the present disclosure;

FIG. 1B and FIG. 1C are diagrams of application system frameworks according to some embodiments of the present disclosure;

FIG. 1D is a diagram of an optional hardware structure of a terminal according to some embodiments of the present disclosure;

FIG. 2 is a diagram of a structure of a server according to some embodiments of the present disclosure;

FIG. 3 is a diagram of a system architecture according to some embodiments of this disclosure;

FIG. 4A shows a procedure of a cloud service according to some embodiments of the present disclosure;

FIG. 4B is a diagram of an application scenario according to some embodiments of the present disclosure;

FIG. 5 is a schematic flowchart of a data processing method according to an embodiment of this disclosure;

FIG. 6 to FIG. 8 are diagrams of processing of a data processing method according to embodiments of this disclosure;

FIG. 9A is a diagram of processing of a data processing method according to an embodiment of this disclosure;

FIG. 9B is a diagram of beneficial effect according to an embodiment of this disclosure;

FIG. 10 is a diagram of a structure of a data processing apparatus according to an embodiment of this disclosure;

FIG. 11 is a diagram of a structure of an execution device according to an embodiment of this disclosure;

FIG. 12 is a diagram of a structure of a training device according to an embodiment of this disclosure; and

FIG. 13 is a diagram of a structure of a chip according to an embodiment of this disclosure.

### DESCRIPTION OF EMBODIMENTS

The following describes embodiments of the present disclosure with reference to accompanying drawings in embodiments of the present disclosure. Terms used in embodiments of the present disclosure are merely intended to explain specific embodiments of the present disclosure, and are not intended to limit the present disclosure.

The following describes embodiments of this disclosure with reference to the accompanying drawings. A person of ordinary skill in the art may know that, with development of technologies and emergence of new scenarios, technical solutions provided in embodiments of this disclosure are also applicable to similar technical problems.

In the specification, claims, and accompanying drawings of this disclosure, terms “first”, “second”, and the like are intended to distinguish between similar objects, but do not necessarily indicate a specific order or sequence. It should be understood that the terms used in such a way may be interchangeable in proper circumstances, which is merely a distinguishing manner used when objects having a same attribute are described in embodiments of this disclosure. In addition, terms “include”, “have”, and any variants thereof mean to cover the non-exclusive inclusion, so that a process, method, system, product, or device that includes a series of units is not necessarily limited to those units, but may include other units not expressly listed or inherent to the process, method, product, or device.

Terms “substantially”, “about”, and the like are used in this specification as approximate terms rather than degree terms, and are intended to take into account inherent deviations of measured values or calculated values that are known to a person of ordinary skill in the art. In addition, when embodiments of the present disclosure are described, “may” is used to mean “one or more possible embodiments”. Terms “use”, “using”, and “used” used in this specification may be considered to be synonymous with terms “utilize”, “utilizing”, and “utilized” respectively. In addition, the term “example” is intended to mean an example or an illustration.

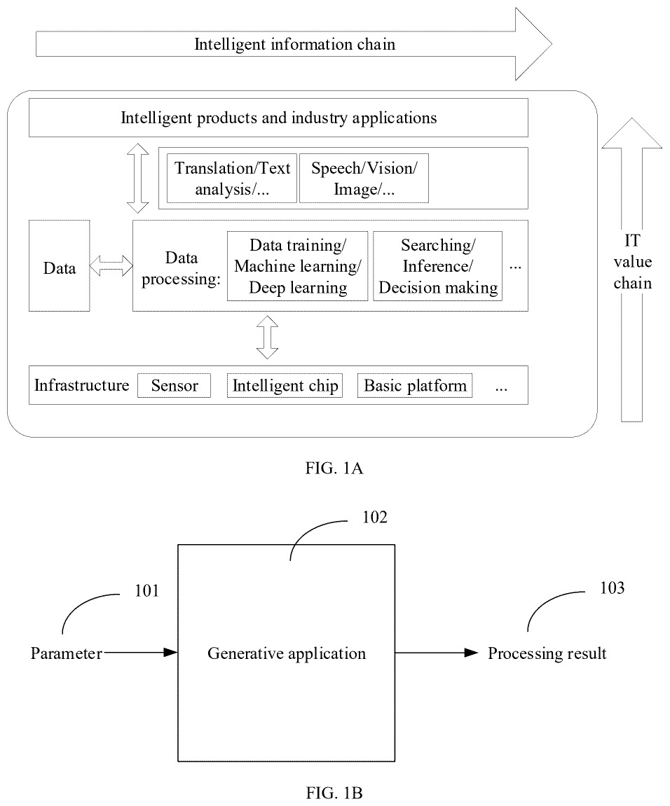

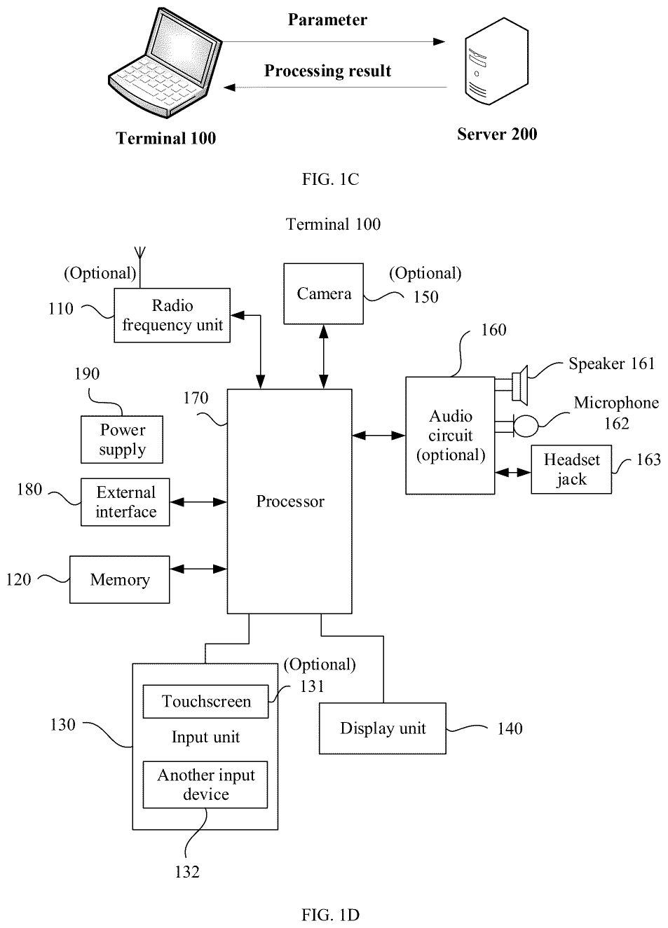

An overall working procedure of an artificial intelligence system is first described. FIG. 1A is a diagram of a structure of a main framework of artificial intelligence. The following describes the main framework of artificial intelligence from two perspectives: “intelligent information chain” (horizontal axis) and “IT value chain” (vertical axis). The “intelligent information chain” reflects a series of processes from obtaining data to processing the data. For example, the process may be a general process of intelligent information perception, intelligent information representation and formation, intelligent reasoning, intelligent decision-making, and intelligent execution and output. In this process, the data undergoes a refinement process of “data-information-knowledge-intelligence”. The “IT value chain” reflects values brought by artificial intelligence to the information technology industry from an underlying infrastructure and information (provision and processing technology implementation) of artificial intelligence to an industrial ecological process of a system.

### (1) Infrastructure

The infrastructure provides computational support for the artificial intelligence system, enables communication with the external world, and offers support by using a basic platform. The infrastructure communicates with the external world via sensors. Computing capabilities are provided by intelligent chips (hardware acceleration chips, for example, CPUs, NPUs, GPUS, ASICs, or FPGAs). The basic platform includes related platform assurance and support such as distributed computing frameworks and networks, and may include cloud storage and computing, interconnected networks, and the like. For example, the sensors communicate with the external world to obtain data, and the data is provided to intelligent chips for computing in a distributed computing system provided by the basic platform.

### (2) Data

Data at an upper layer of the infrastructure indicates a data source in the artificial intelligence field. The data relates to graphs, images, speeches, and texts, and further relates to internet of things data of conventional devices. The data includes service data of existing systems and perception data such as force, displacement, liquid level, temperature, and humidity.

### (3) Data Processing

The data processing typically includes data training, machine learning, deep learning, searching, reasoning, decision making, and the like.

The machine learning and the deep learning enable symbolic and formal intelligent information modeling, extraction, preprocessing, training, and the like of data.

The reasoning is a process computers or intelligent systems that simulates human intelligent reasoning methods. Based on reasoning control policies, it utilizes formalized information to enable machine thinking and problem resolving, with typical functions including searching and matching.

The decision making is a process of making decisions by reasoning intelligent information, with functions including classification, ranking, prediction, and the like

### (4) General Capability

After data undergoes the aforementioned data processing, some general capabilities can be developed based on data processing results. For example, the general capabilities may be algorithms or general systems, for example, translation, text analysis, computer vision processing, speech recognition, and image recognition.

### (5) Intelligent Products and Industry Applications

The intelligent products and industry applications are products and applications of the artificial intelligence system in various fields, and are encapsulation for an overall artificial intelligence solution, so that decision making for intelligent information is productized and the applications are implemented. Application fields thereof mainly include an intelligent terminal, intelligent transportation, intelligent healthcare, autonomous driving, a smart city, and the like.

This disclosure may be applied to the natural language processing field in the artificial intelligence field. The following uses natural language processing as an example to describe a plurality of application scenarios implemented in products.

Application scenarios of this disclosure are first described. This disclosure may be applied to, but not limited to, applications (which may be briefly referred to as generative applications below) having an image generation or natural language synthesis function or a cloud service provided by a cloud-side server. The following separately provides descriptions.

### 1. Generative Application

In embodiments of this disclosure, a product form may be a generative application. The generative application may run on terminal devices or cloud-side servers.

In an embodiment, the generative application may implement image generation tasks to obtain processing results.

For example, the generative application may implement at least image generation tasks that are based on a diffusion method, but this is not limited thereto.

In an embodiment, users may open the generative application installed on terminal devices, and input image data and text data (text may be triggered according to instructions, and may not be actively input by the users). The generative application may process images and text by using a model obtained through training according to a method provided in embodiments of this disclosure, or process images and texts according to a method provided in embodiments of this disclosure, and present processing results to the users (where the processing results may be presented in a manner including but not limited to displaying, playing, saving, or uploading to a cloud side).

In an embodiment, users may open the generative application installed on terminal devices, and input image data and text data. The generative application may send the image data and the text data to the cloud-side server. The cloud-side server processes images or text by using a model obtained through training according to a method provided in embodiments of this disclosure, and returns processing results to the terminal devices. The terminal device may present the processing result to the users (where the processing results may be presented in a manner including but not limited to displaying, playing, saving, or uploading to a cloud side).

For example, the image generation task may be specifically applied to, but not limited to, the following scenarios:

### Scenario 1: Detection Data Generation in Autonomous Driving Scenarios

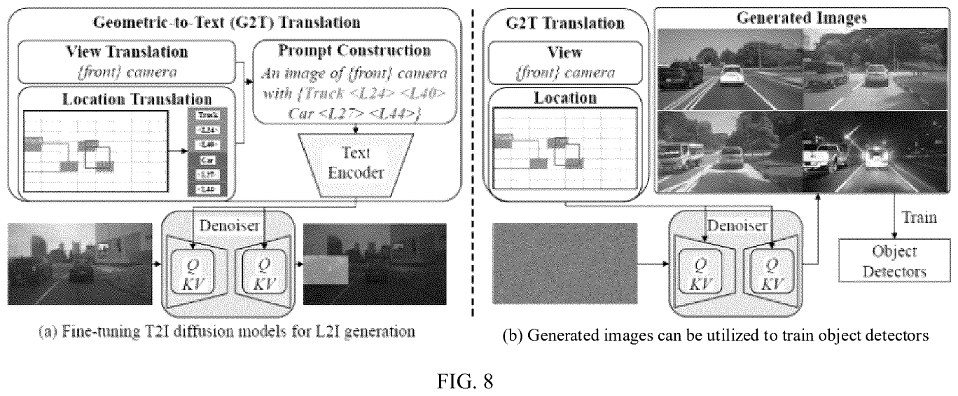

In a scenario of autonomous driving detection data generation, images with rich, real, and diversified traffic environments need to be generated. These images need to include various road types (such as city streets and highways), different weather conditions (such as sunny days, rainy days, and snowy days), a plurality of types of traffic participants (such as pedestrians, cyclists, cars, and trucks), and various traffic rules and signals (such as traffic lights, parking signs, and crosswalks). In addition, the generated images further need to consider various camera viewpoints and locations, to simulate a visual perception capability of an autonomous driving system under an actual road condition. As shown in FIG. 8, given a layout of an autonomous driving scenario in the lower left corner, a plurality of types of autonomous driving data with a same layout may be generated (as shown in the upper right corner of FIG. 8).

### Scenario 2: Smart Watch Face Data Generation

In a scenario of smart watch face data generation, diversified, personalized, and highly authentic watch face elements need to be generated based on a specific watch face layout. These watch face elements include hands (hour, minute, and second) and information such as a day-of-week display, a date display, a step count, heart rate monitoring, and a battery level. In addition, a generated watch face further needs to consider various design styles, color schemes, and fonts, to meet a personalized requirement and an aesthetic preference of a user.

Scenario 3: AI Model Generation in an e-Commerce Scenario

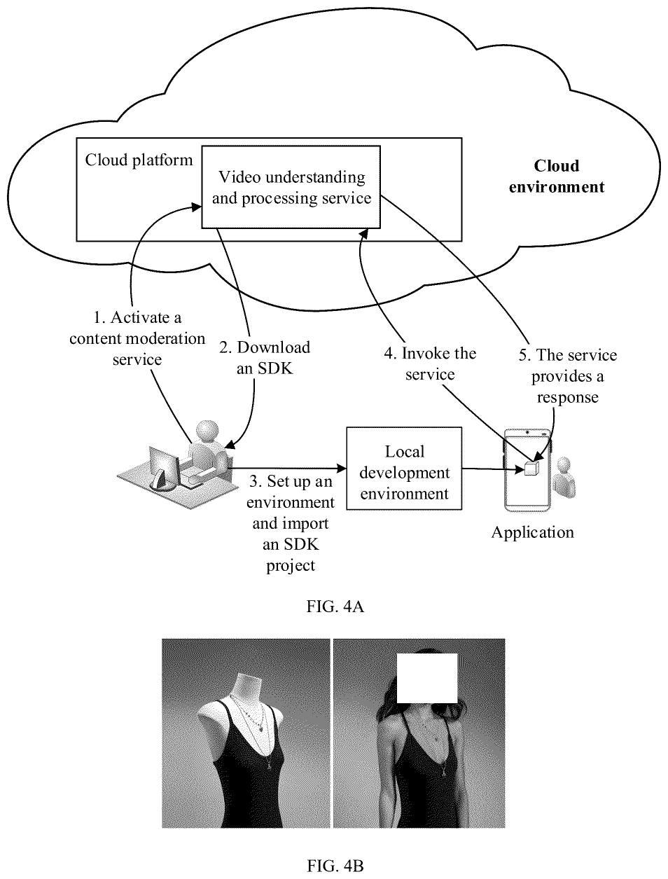

With reference to FIG. 4B, during AI model generation in the e-commerce scenario, diversified clothing combinations need to be generated based on input specified model styling, to be presented to potential consumers. First, a model needs to receive the model styling input by a user, for example, features such as a posture and a pose. Then, based on these features, a generation algorithm generates a series of clothing combinations that match the model styling. These combinations may include different types of tops, pants, skirts, jackets, shoes, and the like. In a generation process, the algorithm needs to consider styles, colors, patterns, and other details of clothing, and ensure that the generated combinations are visually attractive and authentic. In addition, to meet requirements of different consumers, the generated clothing combinations need be diversified, covering different styles, occasions, and seasons.

The following describes the generative applications in embodiments of this disclosure separately from the perspectives of a functional architecture and a product architecture for function implementation.

FIG. 1B is a diagram of a functional architecture of a generative application according to an embodiment of this disclosure.

In an embodiment, as shown in FIG. 1B, the generative application 102 may receive an input parameter 101 (for example, including images or text) and generate a processing result 103. The generative application 102 may be executed on (for example) at least one computer system, and include computer code. When the computer code is executed by one or more computers, the computer is caused to execute a model obtained through training according to the method provided in embodiments of this disclosure.

FIG. 1C is a diagram of an entity architecture for running a generative application according to an embodiment of this disclosure.

FIG. 1C is a diagram of a system architecture. The system may include a terminal 100 and a server 200. The server 200 may include one or more servers (an example in which one server is included is used for description in FIG. 1C), and the server 200 may provide an image synthesis function or a natural language generation function for one or more terminals.

A generative application may be installed on the terminal 100, or a web page related to the image synthesis function or the natural language generation function may be opened on the terminal 100. The application or the web page may provide an interface. The terminal 100 may receive a related parameter input by a user on the interface of the image synthesis function or the natural language generation function, and send the parameter to the server 200. The server 200 may obtain a processing result based on the received parameter, and return the processing result to the terminal 100.

It should be understood that, in some optional embodiments, the terminal 100 may alternatively autonomously complete an action of obtaining a processing result based on a received parameter without a need to cooperate with the server. This is not limited in embodiments of this disclosure.

The following describes a product form of the terminal 100 in FIG. 1C.

The terminal 100 in embodiments of this disclosure may be a mobile phone, a tablet computer, a wearable device, a vehicle-mounted device, an augmented reality (AR)/virtual reality (VR) device, a notebook computer, an ultra-mobile personal computer (UMPC), a netbook, a personal digital assistant (PDA), or the like. This is not limited in embodiments of this disclosure.

FIG. 1D is a diagram of an optional hardware structure of the terminal 100.

With reference to FIG. 1D, the terminal 100 may include components such as a radio frequency unit 110, a memory 120, an input unit 130, a display unit 140, a camera 150 (optional), an audio circuit 160 (optional), a speaker 161 (optional), a microphone 162 (optional), a processor 170, an external interface 180, and a power supply 190. A person skilled in the art may understand that FIG. 1D is merely an example of the terminal or a multi-function device and does not constitute a limitation on the terminal or the multi-function device. The terminal or the multi-function device may include more or fewer components than those shown in the figure, a combination of some components, or different components.

The input unit 130 may be configured to: receive input digital or character information, and generate a key signal input related to a user setting and function control of a portable multi-function apparatus. Specifically, the input unit 130 may include a touchscreen 131 (optional) and/or another input device 132. The touchscreen 131 may collect a touch operation performed by the user on or near the touchscreen 131 (for example, an operation performed by the user on or near the touchscreen by using any appropriate object such as a finger, a joint, or a stylus), and drive a corresponding connection apparatus based on a preset program. The touchscreen may detect a touch action performed by the user on the touchscreen, convert the touch action into a touch signal, and send the touch signal to the processor 170, and can receive and execute a command sent by the processor 170. The touch signal includes at least touch point coordinate information. The touchscreen 131 may provide an input interface and an output interface between the terminal 100 and the user. In addition, the touchscreen may be of a plurality of types, such as a resistive type, a capacitive type, an infrared ray type, and a surface acoustic wave type. In addition to the touchscreen 131, the input unit 130 may include another input device. Specifically, the another input device 132 may include but is not limited to one or more of a physical keyboard, a functional button (for example, a volume control button or an on/off button), a trackball, a mouse, and a joystick.

The another input device 132 may receive input image data or text data.

The display unit 140 may be configured to display information input by the user, information provided for the user, various menus of the terminal 100, an interaction interface, a file, and/or playing of any multimedia file. In embodiments of this disclosure, the display unit 140 may be configured to display an interface, a processing result, and the like of a generative application.

The memory 120 may be configured to store instructions and data. The memory 120 may mainly include an instruction storage region and a data storage region. The data storage region may store various types of data such as a multimedia file and a text. The instruction storage region may store software units such as an operating system, an application, and instructions required by at least one function, or subsets and extended sets thereof. The memory 120 may further include a non-volatile random access memory, and provide the processor 170 with management of hardware, software, and data resources in a computing processing device, support for control on software and applications, and the like. The memory 120 is further configured to: store a multimedia file, and run a program and store an application.

The processor 170 is a control center of the terminal 100, connects parts of the entire terminal 100 by using various interfaces and lines, and executes various functions of the terminal 100 and processes data by running or executing the instructions stored in the memory 120 and invoking the data stored in the memory 120, to entirely control the terminal device. Optionally, the processor 170 may include one or more processing units. Preferably, an application processor and a modem processor may be integrated into the processor 170. The application processor mainly processes an operating system, a user interface, an application, and the like. The modem processor mainly processes wireless communication. It may be understood that the modem processor may alternatively not be integrated into the processor 170. In some embodiments, the processor and the memory may be implemented on a single chip. In some embodiments, the processor and the memory may alternatively be separately implemented on independent chips. The processor 170 may be further configured to: generate a corresponding operation control signal, send the operation control signal to a corresponding component in the computing processing device, and read and process data in software, especially read and process the data and the program in the memory 120, so that each functional module performs a corresponding function, to control the corresponding component to perform an action according to an instruction.

The memory 120 may be configured to store software code related to the data processing method. The processor 170 may perform the data processing method of the chip, or may schedule other units (for example, the input unit 130 and the display unit 140) to implement corresponding functions.

The radio frequency unit 110 (optional) may be configured to receive and send information or receive and send signals in a call process. For example, after receiving downlink information of a base station, the radio frequency unit 110 sends the downlink information to the processor 170 for processing. In addition, the radio frequency unit 110 sends uplink-related data to the base station. Usually, an RF circuit includes but is not limited to an antenna, at least one amplifier, a transceiver, a coupler, a low noise amplifier (LNA), and a duplexer. In addition, the radio frequency unit 110 may further communicate with a network device and another device through wireless communication. The wireless communication may use any communication standard or protocol, including but not limited to a global system for mobile communications (GSM), a general packet radio service (GPRS), code division multiple access (CDMA), wideband code division multiple access (WCDMA), long term evolution (LTE), an email, a short message service (SMS), and the like.

In embodiments of this disclosure, the radio frequency unit 110 may send image data or text data to the server 200, and receive a processing result sent by the server 200.

It should be understood that the radio frequency unit 110 is optional, and may be replaced with another communication interface, for example, may be a network interface.

The terminal 100 further includes the power supply 190 (for example, a battery) for supplying power to various components. Preferably, the power supply may be logically connected to the processor 170 by using a power management system, so that functions such as charging and discharging management and power consumption management are implemented by using the power management system.

The terminal 100 further includes the external interface 180. The external interface may be a standard micro USB interface, or may be a multi-pin connector, and may be configured to connect the terminal 100 to another apparatus for communication, or may be configured to connect to a charger to charge the terminal 100.

Although not shown, the terminal 100 may further include a flash, a wireless fidelity (Wi-Fi) module, a Bluetooth module, sensors with different functions, and the like. Details are not described herein. Some or all of methods described below may be applied to the terminal 100 shown in FIG. 1D.

The following describes a product form of the server 200 in FIG. 1C.

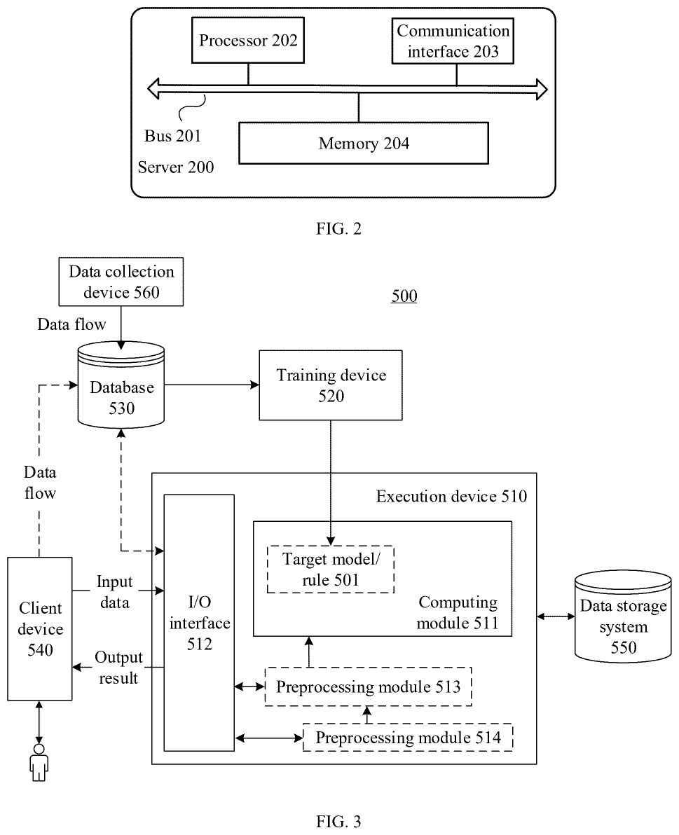

FIG. 2 is a diagram of a structure of the server 200. As shown in FIG. 2, the server 200 includes a bus 201, a processor 202, a communication interface 203, and a memory 204. The processor 202, the memory 204, and the communication interface 203 communicate with each other through the bus 201.

The bus 201 may be a peripheral component interconnect (PCI) bus, an extended industry standard architecture (EISA) bus, or the like. The bus may be classified as an address bus, a data bus, a control bus, or the like. For ease of representation, only one thick line is used to represent the bus in FIG. 2, but this does not mean that there is only one bus or only one type of bus.

The processor 202 may be any one or more of processors such as a central processing unit (CPU), a graphics processing unit (GPU), a microprocessor (MP), or a digital signal processor (DSP).

The memory 204 may include a volatile memory, for example, a random access memory (RAM). The memory 204 may further include a non-volatile memory, for example, a read-only memory (ROM), a flash memory, a hard disk drive (HDD), or a solid-state drive (SSD).

The memory 204 may be configured to store software code related to the data processing method. The processor 202 may perform the data processing method of a chip, or may schedule another unit to implement a corresponding function.

It should be understood that the terminal 100 and the server 200 may be central or distributed devices. Processors (for example, the processor 170 and the processor 202) in the terminal 100 and the server 200 each may be a hardware circuit (for example, an application-specific integrated circuit (ASIC), a field programmable gate array (FPGA), a general-purpose processor, a digital signal processor (DSP), a microprocessor, or a microcontroller), or a combination of these hardware circuits. For example, the processor may be a hardware system that has an instruction execution function, for example, a CPU or a DSP, or may be a hardware system that does not have an instruction execution function, for example, an ASIC or an FPGA, or may be a combination of the hardware system that does not have the instruction execution function and the hardware system that has the instruction execution function.

It should be understood that operations related to a model inference process in embodiments of this disclosure relate to an AI-related operation. When the AI operation is performed, an instruction execution architecture of the terminal device and the server is not limited to the architecture in which the processor and the memory are combined. The system architecture provided in embodiments of this disclosure is described in detail below with reference to FIG. 3.

FIG. 3 is a diagram of a system architecture according to an embodiment of this disclosure. As shown in FIG. 3, the system architecture 500 includes an execution device 510, a training device 520, a database 530, a client device 540, a data storage system 550, and a data collection device 560.

The execution device 510 includes a computing module 511, an I/O interface 512, a preprocessing module 513, and a preprocessing module 514. The computing module 511 may include a target model/rule 501, and the preprocessing module 513 and the preprocessing module 514 are optional.

The execution device 510 may be the terminal device or the server that runs the generative application.

The data collection device 560 is configured to collect a training sample. The training sample may be image data, text data, or the like. After collecting the training sample, the data collection device 560 stores the training sample in the database 530.

The training device 520 may train a to-be-trained neural network (for example, a neural network model (for example, including a text encoder and a diffusion model) in embodiments of this disclosure) based on the training sample maintained in the database 530, to obtain the target model/rule 501.

It should be understood that the training device 520 may perform a pre-training process on the to-be-trained neural network based on the training sample maintained in the database 530, or perform fine-tuning on a model based on pre-training.

It should be noted that during actual application, the training sample maintained in the database 530 is not necessarily collected by the data collection device 560, and may be received from another device. In addition, it should be noted that the training device 520 does not necessarily completely obtain the target model/rule 501 through training based on the training sample maintained in the database 530, and may perform model training by obtaining a training sample from a cloud or another location. The foregoing descriptions should not be construed as any limitation on embodiments of this disclosure.

The target model/rule 501 obtained through training by the training device 520 may be applied to different systems or devices, for example, applied to the execution device 510 shown in FIG. 3. The execution device 510 may be a terminal, for example, a mobile phone terminal, a tablet computer, a notebook computer, an augmented reality (AR)/virtual reality (VR) device, or a vehicle-mounted terminal; or may be a server or the like.

Specifically, the training device 520 may transfer a trained model to the execution device 510.

In FIG. 3, the input/output (I/O) interface 512 is configured for the execution device 510, and is configured to exchange data with an external device. A user may input data (for example, image data or text data in embodiments of this disclosure) to the I/O interface 512 through the client device 540.

The preprocessing module 513 and the preprocessing module 514 are configured to perform preprocessing based on the input data received by the I/O interface 512. It should be understood that the preprocessing module 513 and the preprocessing module 514 may not exist, or there may be only one preprocessing module. When the preprocessing module 513 and the preprocessing module 514 do not exist, the computing module 511 may be directly used to process the input data.

When the execution device 510 preprocesses the input data, or when the computing module 511 in the execution device 510 performs a related processing process such as computing, the execution device 510 may invoke data, code, and the like in the data storage system 550 for corresponding processing, and may store data, instructions, and the like obtained through corresponding processing into the data storage system 550.

Finally, the I/O interface 512 provides a processing result for the client device 540, to provide the processing result for the user.

In the case shown in FIG. 3, the user may manually give input data, and “manually giving the input data” may be operated on an interface provided by the I/O interface 512. In another case, the client device 540 may automatically send the input data to the I/O interface 512. If the client device 540 is required to automatically send the input data, authorization from the user needs to be obtained, and the user may set corresponding permission in the client device 540. The user may view, on the client device 540, a result output by the execution device 510. The result may be presented in a specific manner, for example, display, sound, or an action. The client device 540 may also be used as a data collection end, collect the input data input into the I/O interface 512 and the output result output from the I/O interface 512 that are shown in the figure, use the input data and the output result as new sample data, and store the new sample data in the database 530. Certainly, the client device 540 may alternatively not perform collection. Instead, the I/O interface 512 directly stores, into the database 530 as new sample data, the input data input into the I/O interface 512 and the output result output from the I/O interface 512 that are shown in the figure.

It should be noted that FIG. 3 is merely a diagram of a system architecture according to an embodiment of this disclosure. A location relationship between devices, components, modules, and the like shown in the figure does not constitute any limitation. For example, in FIG. 3, the data storage system 550 is an external memory relative to the execution device 510. In another case, the data storage system 550 may alternatively be disposed in the execution device 510. It should be understood that the execution device 510 may be deployed in the client device 540.

Details from a perspective of model inference are as follows:

In embodiments of this disclosure, the computing module 511 in the execution device 510 may obtain the code stored in the data storage system 550, to implement operations related to a model inference process in embodiments of this disclosure.

In embodiments of this disclosure, the computing module 511 of the execution device 510 may include a hardware circuit (for example, an ASIC, a FPGA, a general-purpose processor, a DSP, a microprocessor, or a microcontroller), or a combination of these hardware circuits. For example, the computing module 511 may be a hardware system that has an instruction execution function, for example, a CPU or a DSP, or may be a hardware system that does not have an instruction execution function, for example, an ASIC or an FPGA, or may be a combination of the hardware system that does not have the instruction execution function and the hardware system that has the instruction execution function.

Specifically, the computing module 511 in the execution device 510 may be the hardware system that has the instruction execution function. The operations related to the model inference process provided in embodiments of this disclosure may be software code stored in a memory. The computing module 511 in the execution device 510 may obtain the software code from the memory, and execute the obtained software code to implement the operations related to the model inference process provided in embodiments of this disclosure.

It should be understood that the computing module 511 in the execution device 510 may be the combination of the hardware system that does not have the instruction execution function and the hardware system that has the instruction execution function. Some of the operations related to the model inference process provided in embodiments of this disclosure may alternatively be implemented by the hardware system that does not have the instruction execution function in the computing module 511 in the execution device 510. This is not limited herein.

Details from a perspective of model training are as follows:

In embodiments of this disclosure, the training device 520 may obtain code stored in a memory (which is not shown in FIG. 3, and may be integrated into the training device 520 or separately deployed from the training device 520), to implement operations related to model training in embodiments of this disclosure.

In embodiments of this disclosure, the training device 520 may include a hardware circuit (for example, an ASIC, a FPGA, a general-purpose processor, a DSP, a microprocessor, or a microcontroller), or a combination of these hardware circuits. For example, the training device 520 may be a hardware system that has an instruction execution function, for example, a CPU or a DSP, or may be a hardware system that does not have an instruction execution function, for example, an ASIC or a FPGA, or may be a combination of the hardware system that does not have the instruction execution function and the hardware system that has the instruction execution function.

It should be understood that the training device 520 may be the combination of the hardware system that does not have the instruction execution function and the hardware system that has the instruction execution function. Some of the operations related to model training provided in embodiments of this disclosure may alternatively be implemented by the hardware system that does not have the instruction execution function in the training device 520. This is not limited herein.

### 2. Image Synthesis or Natural Language Generation Function-Related Cloud Service Provided by a Server

In an embodiment, the server may provide an image synthesis function-related service for a device side by using an application programming interface (API).

A terminal device may send a related parameter (for example, data such as an image or a text) to the server through the API provided by a cloud. The server may obtain a processing result or the like based on the received parameter, and return the processing result to the terminal.

For descriptions of the terminal and the server, refer to the descriptions in the foregoing embodiments. Details are not described herein again.

FIG. 4A shows a procedure of using an image synthesis function-related cloud service provided by a cloud platform.

1. Activate and purchase a content moderation service.

2. A user may download a software development kit (SDK) corresponding to the content moderation service. Usually, the cloud platform provides SDKs of a plurality of development versions for the user to select based on a development environment requirement, for example, a Java-version SDK, a Python-version SDK, a PHP-version SDK, and an Android-version SDK.

3. After locally downloading an SDK of a corresponding version based on the requirement, the user imports an SDK project to a local development environment, and performs configuration and debugging in the local development environment. Another function may be further developed in the local development environment, to form an application that integrates an image synthesis function-related capability.

4. During use of an image synthesis function-related application, when the image synthesis function is required, invocation of an image synthesis function-related API may be triggered. When the application triggers the image synthesis function, an API request is initiated to a running instance of the image synthesis function-related service in a cloud environment. The API request carries an image or a text, and the running instance in the cloud environment processes the image to obtain a processing result.

5. The cloud environment returns the processing result to the application. In this way, the image synthesis function is invoked once.

Embodiments of this disclosure relate to massive application of a neural network. Therefore, for ease of understanding, the following first describes related terms and related concepts such as the neural network in embodiments of this disclosure.

### (1) Neural Network

The neural network may include neurons. The neuron may be an operation unit that uses xₛ (namely, input data) and an intercept of 1 as an input. An output of the operation unit may be as follows:

$${h}_{W , b} ( x ) = f ( {W}^{T} x ) = f ( {\sum }_{s = 1}^{n} {W}_{s} {x}_{s} + b )$$

s=1, 2, . . . , n, n is a natural number greater than 1, Wₛ is a weight of xₛ, and b is a bias of the neuron. f is an activation function of the neuron, and is used to introduce a non-linear characteristic into the neural network to convert an input signal in the neuron into an output signal. The output signal of the activation function may be used as an input of a next convolutional layer, and the activation function may be a sigmoid function. The neural network is a network formed by linking a plurality of single neurons together. To be specific, an output of a neuron may be an input of another neuron. An input of each neuron may be connected to a local receptive field of a previous layer to extract a feature of the local receptive field. The local receptive field may be a region including several neurons.

### (2) Transformer Layer

A neural network includes an embedding layer and at least one transformer layer. The at least one transformer layer may be N transformer layers (N is an integer greater than 0), and each transformer layer includes an attention layer, an add and normalization (add & norm) layer, a feedforward (feedforward) layer, and an add and normalization layer that are adjacent in sequence. At the embedding layer, embedding processing is performed on a current input to obtain a plurality of embedding vectors. At the attention layer, P input vectors are obtained from a previous layer of a first transformer layer. Any first input vector in the P input vectors is used as a center. An intermediate vector corresponding to the first input vector is obtained based on an association degree between the first input vector and each input vector within a preset attention window range. In this way, P intermediate vectors corresponding to the P input vectors are determined. At a pooling layer, the P intermediate vectors are combined into Q output vectors. A plurality of output vectors obtained from a last transformer layer in transformer layers are used as feature representations of the current input.

### (3) Attention Mechanism

The attention mechanism simulates an internal process of a biological observation behavior, is a mechanism that aligns internal experience with external feelings to increase observation precision of some regions, and can quickly select high-value information from a large amount of information by using limited attention resources. The attention mechanism can quickly extract an important feature of sparse data, and therefore is widely used in natural language processing tasks, especially machine translation. A self-attention mechanism is improvement of the attention mechanism. The self-attention mechanism is less dependent on external information, and is better at capturing an internal correlation of data or features. An essential idea of the attention mechanism may be rewritten as the following formula:

$$Attention ( q , Source ) = {\sum }_{i = 1}^{{L}_{x}} {α}_{i} \cdot {v}_{i}$$

$${α}_{i} = \frac{exp ( score ( q , {k}_{i} ) )}{{\sum }_{j = 1}^{{L}_{x}} exp ( score ( q , {k}_{j} ) )} ,$$

Lx=∥Source∥ represents a length of a source. The formula means that constituent elements in the source are assumed to include a series of data pairs, score(q, kᵢ) represents similarity or a correlation between a query and an i^{th} key, αᵢ represents an attention weight of the query for the i^{th} key, and vᵢ represents an i^{th} value. In this case, an element query in a target is given, similarity or a correlation between the query and each key is calculated to obtain a weight coefficient of a value corresponding to each key, and then weighted summation is performed on values, to obtain a final attention value. Therefore, in essence, the attention mechanism is to perform weighted summation on values of the elements in the source, and a query and a key are used to calculate a weight coefficient of a corresponding value. Conceptually, attention may be understood as selecting a small amount of important information from a large amount of information, focusing on the important information, and ignoring most of unimportant information. A process of focusing is reflected in calculation of the weight coefficient. A greater weight indicates greater focus on a value corresponding to the weight, that is, the weight indicates importance of information, and the value is the information corresponding to the weight. The self-attention mechanism may be understood as an intra-attention mechanism. The attention mechanism occurs between the element query in the target and all the elements in the source. The self-attention mechanism is an attention mechanism that occurs between elements in a source or between elements in a target, and may also be understood as an attention calculation mechanism in a special case of target=source. A specific calculation process of the self-attention mechanism is the same except that a calculation object changes.

### (4) Natural Language Processing (NLP)

A natural language is a human language, and natural language processing (NLP) is processing of the human language. Natural language processing is a process of systematic analysis, understanding, and information extraction of text data in an intelligent and efficient manner. Through use of NLP and components of NLP, massive chunks of text data can be managed, or a large quantity of automated tasks can be executed, and various problems such as automatic summarization, machine translation (MT), named entity recognition (NER), relation extraction (RE), information extraction (IE), sentiment analysis, speech recognition, a question answering system, and topic segmentation can be resolved.

### (5) Back Propagation Algorithm

A convolutional neural network may correct a value of a parameter in an initial super-resolution model in a training process according to an error back propagation (BP) algorithm, so that an error loss of reconstructing the super-resolution model becomes smaller. Specifically, an input signal is transferred forward until an error loss occurs at an output, and the parameter in the initial super-resolution model is updated based on back propagation error loss information, to make the error loss converge. The back propagation algorithm is an error-loss-driven back propagation process intended to obtain a parameter, for example, a weight matrix, of an optimal super-resolution model.

### (6) Loss Function

In a process of training a deep neural network, because it is expected that an output of the deep neural network is as close as possible to a value that is actually expected to be predicted, a current predicted value of the network may be compared with an actually expected target value, and then a weight vector at each layer of the neural network is updated based on a difference between the current predicted value and the target value (certainly, there is usually an initialization process before the first update, to be specific, a parameter is preconfigured for each layer of the deep neural network). For example, if the predicted value of the network is large, the weight vector is adjusted to decrease the predicted value, and adjustment is continuously performed, until the deep neural network can predict the actually expected target value or a value that is very close to the actually expected target value. Therefore, “how to obtain, through comparison, the difference between the predicted value and the target value” needs to be predefined. This is a loss function or an objective function. The loss function and the objective function are important equations that are used to measure the difference between the predicted value and the target value. The loss function is used as an example. A higher output value (loss) of the loss function indicates a larger difference. Therefore, training of the deep neural network is a process of reducing the loss as much as possible.

### (7) Diffusion Model

The diffusion model is a generative model used to generate data such as images and text. A core idea of the diffusion model is to restore original data by performing noise diffusion on the data and then gradually removing noise. The diffusion model includes two phases: a forward process (noise diffusion) and a reverse process (denoising recovery).

### (8) Layout-to-Image (L2I)

L2I is a computer vision task aimed at generating a realistic image based on an input semantic layout. The semantic layout usually includes information about a category, a location, and a shape of an object, and is used to guide appearance of the object in the final image in a generation process.

In recent years, diffusion models have made significant progress and gained considerable attention in the generative field. Although probabilistic diffusion models have shown outstanding performance in content creation and have become one of the most popular generative models, there are still some limitations when the probabilistic diffusion models are applied to data generation of perception tasks (such as object detection). Specifically, in data generation of complex perception tasks such as object detection and pose estimation, fine-grained geometric control, for example, control of a bounding box location, is required. However, performance of existing diffusion models is not ideal in this aspect, and it is difficult to accurately control locations and relative relationships of objects in generated images.

To resolve the foregoing problem, embodiments of this disclosure provide a data processing method. The following describes in detail the data processing method in embodiments of this disclosure with reference to accompanying drawings.

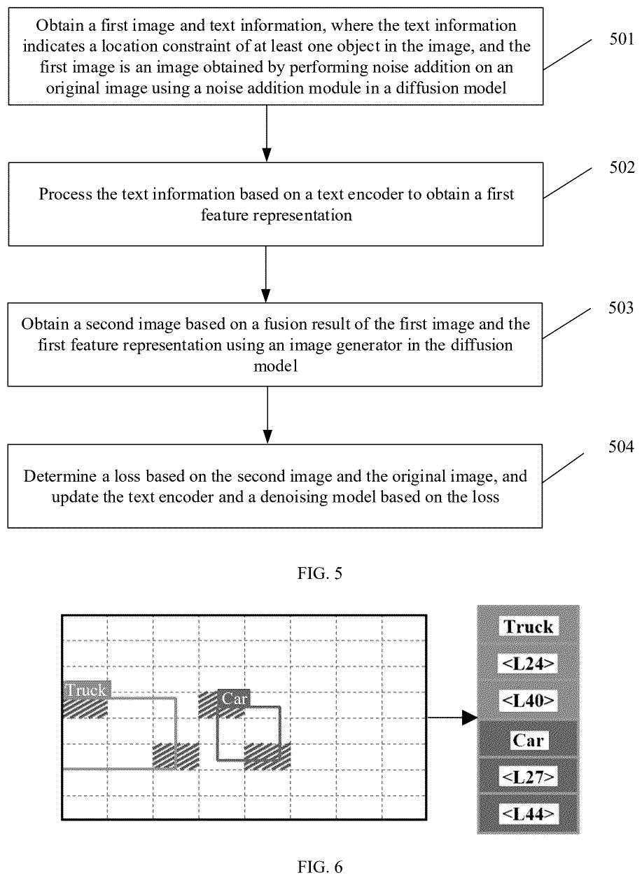

FIG. 5 is a schematic flowchart of a data processing method according to an embodiment of this disclosure. As shown in FIG. 5, the data processing method provided in this embodiment of this disclosure may include operations 501 to 503. The following separately describes these operations in detail.

Operation 501: Obtain a first image and text information, where the text information indicates a location constraint of at least one object in an image, and the first image is an image obtained by performing noise addition using a noise addition module in a diffusion model.

In an embodiment, the first image may be an image obtained by performing noise addition on an original image using the noise addition module in the diffusion model.

The original image may be locally pre-stored in a terminal or a server, may be obtained by the terminal from the outside (for example, the internet), or may be collected by the terminal in real time, for example, collected in real time through a camera of the terminal.

The noise addition may be a stochastic noise addition process of forward propagation in the diffusion model.

In an embodiment, to generate an image that has a style similar to that of the original image and that meets a specific geometric constraint feature, the original image and text information that represents the geometric constraint feature may be first specified as a prompt.

In an embodiment, the text information may be obtained. The text information may include a geometric control constraint (including, but not limited to, control information such as a location constraint and a pose) in an image to be generated by using the diffusion model. For example, the text information may indicate the location constraint of the at least one object in the image. The object may be a vehicle, a person, or the like.

The text information may be geometric control information used to describe an object included in the original image. In this case, the generated image of the diffusion model is equivalent to an image that has a same geometric feature as the original image. This is usually applied to, but not limited to, the foregoing scenario 1 (detection data generation in the autonomous driving scenario) and scenario 2 (watch face image generation).

Alternatively, the text information may be geometric control information indicating an object that is not included in the original image but needs to be included in the generated image. This is usually applied to, but not limited to, the foregoing scenario 3 (AI model generation in the e-commerce scenario).

In an embodiment, the text information specifically includes a size of a detection box corresponding to each object in the image and a location of the detection box in the image.

For example, the size of the detection box and the location of the detection box in the image may be indicated by using coordinate locations of diagonal endpoints of the detection box in the image.

For example, image spatial coordinates may be divided into grids, and each vertex of a bounding box is represented by a location token corresponding to a location of a grid in which the bounding box is located. For example, the location token may be indication information of the grid in which the bounding box is located.

In the scenario 1 and the scenario 2 described above, an image that has a similar style, a same geometric feature, and a same location feature as the object included in the original image needs to be generated.

To implement the foregoing function, to enable a model finally generated by using the diffusion model to have the geometric feature and the location feature of the object in the original image, a size and a location of a detection box of the included object may be extracted from the original image.

In an embodiment, to ensure authenticity of the object in the generated image, the text information further includes a category of image content in the detection box, or camera viewpoint information present when the first image is captured. The text information includes the category of the image content in the detection box, so that a category of the object in the generated image is consistent with a category of the object included in the original image. The text information includes the viewpoint information, so that a size relationship and a location relationship between objects in the generated image can be more authentic and accurate (for example, meet a constraint of perspective scaling).

For example, the original image may be collected by a camera on a vehicle, and the viewpoint information may be a viewpoint orientation present when the camera captures the original image, for example, front, front left, front right, left, or right.

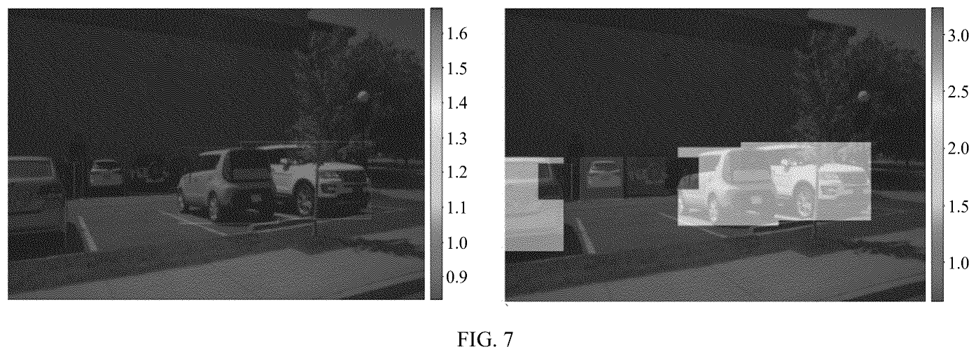

The scenario 1 is used as an example. With reference to FIG. 6 and FIG. 7, for a scenario of detection task data generation, text information may include three parts: a detection box category cᵢ, detection box coordinates bᵢ, and an additional geometric condition v (for example, viewpoint information), where cᵢ and v may be directly represented as corresponding text descriptions. An example of the text description is as follows:

$$L = ( {\{ {c}_{i} , {b}_{i} \}}_{i = 1}^{N} , v )$$

To express continuous bounding box coordinates b; in the text information, spatial coordinates of an image may be divided into grids. Each vertex or the like of a bounding box is represented by a location token corresponding to a location of a grid in which the bounding box is located. As shown in FIG. 6, a category of a detection box on the left is “truck”, and a location constraint is a grid (a 24^{th} grid) in which a top-left vertex of the detection box is located and a grid (a 40^{th} grid) in which a bottom-right vertex of the detection box is located; and a category of a detection box on the right is “car”, and a location constraint is a grid (a 27^{th} grid) in which a top-left vertex of the detection box is located and a grid (a 44^{th} grid) in which a bottom-right vertex of the detection box is located.

For example, the following prompt template may be used to construct the text information:
An image of {view} camera with {bbox}

“view” is camera viewpoint information, and “bbox” is location information and a category of a detection box.

The scenario 2 is used as an example. An image including a watch face may be input as an original image, and text information may be location information and a category of a detection box of each element (for example, a hand, a day-of-week display, a date display, a step count, heart rate monitoring, or a battery level) in the watch face.

In the scenario 3 described above or a similar scenario, an image that meets a specific pose of a person needs to be generated based on an original image. Therefore, the text information needs to indicate the pose of the person.

In an embodiment, the object is a key point on a person for indicating a pose. In other words, the text information may indicate location constraints of a plurality of key points of the person in the image. For example, the key point may be a body joint of the person.

Operation 502: Process the text information based on a text encoder to obtain a first feature representation.

In an embodiment, the text information may be input into the text encoder, to obtain the first feature representation corresponding to the text information. The text encoder may be a model, for example, BERT or GPT. This is not limited herein.

Operation 503: Obtain a second image based on a fusion result of the first image and the first feature representation using an image generator in the diffusion model.

In an embodiment, the first image and the first feature representation may be fused, for example, through attention mechanism-based interaction, to obtain the fusion result. It should be understood that before fusion, dimension adjustment may be further performed on the first feature representation or the first image, so that the first image and the first feature representation have a same size after adjustment, and therefore information exchange can be implemented.

For specific descriptions of the image generator, refer to the descriptions of the diffusion model in a conventional technology. Details are not described herein again.

Operation 504: Determine a loss based on the second image and the original image, and update the text encoder and a denoising model based on the loss.

In an embodiment, the loss may be determined based on the second image and the original image, and the text encoder and the denoising model are updated based on the loss. An updated text encoder and an updated denoising model may generate, based on the original image and the text information, an image that has a style similar to that of the original image and meets a geometric constraint specified in the text information. In this embodiment of this disclosure, a feature representation of text information indicating a location constraint of an object in a generated image and the image are input into the image generator together. Compared with the conventional technology in which only the first image is used as an input of the image generator, in this disclosure, the image generator can more accurately obtain an image that meets a geometric constraint specified in the text information.

In addition, transferability of the text encoder is used, so that a specific conditional encoding network module does not need to be designed for a specific geometric condition, and therefore an entire framework has strong flexibility and scalability.

In an embodiment, to alleviate an imbalance problem of a foreground region in the generated image, values of a loss corresponding to the foreground region and a loss corresponding to a background region may be controlled in a training process, to help the model pay more attention to generation of a foreground object, thereby improving generation effect of the foreground region.

At least one object in the generated image (that is, the second image in this embodiment of this disclosure) may be located in the foreground region in the image. When the loss is constructed, a first loss may be determined based on a foreground region of the second image and a foreground region of the original image; a second loss may be determined based on a background region of the second image and a background region of the original image; and the first loss and the second loss may be fused through weighting to obtain the loss, where a weight corresponding to the first loss is greater than a weight corresponding to the second loss.

In this embodiment of this disclosure, to better complete generation of the foreground object to assist a perception task such as object detection, constant reweighting may be used to distinguish between the foreground region and the background region.

In an embodiment, to alleviate an imbalance problem of the foreground region in the generated image, values of a loss corresponding to a small-area object (or referred to as a small object) in the foreground region and a loss corresponding to a large-area object in the foreground region may be controlled in the training process, to improve generation effect of the small-area object.

In an embodiment, the at least one object includes a first object and a second object; and the first object is located in a first foreground region in the second image, and the second object is located in a second foreground region in the second image. When the loss is constructed, a first sub-loss may be determined based on the first foreground region and a foreground region that is in the original image and that corresponds to the first foreground region; a second sub-loss may be determined based on the second foreground region and a foreground region that is in the original image and that corresponds to the second foreground region; and the first sub-loss and the second sub-loss may be fused through weighting to obtain the first loss, where the first loss is a part of the loss, an area of the first foreground region is greater than that of the second foreground region, and a weight corresponding to the first sub-loss is less than a weight corresponding to the second foreground region. It should be understood that the loss may further include the loss corresponding to the background region.

It should be understood that a specific value of the weight may be related to a value of the area. For example, a larger area indicates a smaller weight.

Weight allocation between the foreground region and the background region or between foreground regions may be referred to as a reweighting process. For example, the mechanism specifically includes two parts:

1. Constant reweighting: A weight of the loss of the foreground region is set to w (w≥1) to distinguish between the foreground region and the background region.

2. Area reweighting: To enhance the generation effect of the model on the small object, an area of each foreground object is further considered. A smaller area has a larger loss weight.

For example, a specific value of a weight may be determined with reference to the following formula:

$${m}_{ij}^{′} = \{ \begin{matrix}w / {c}_{ij}^{p} & ( i , j ) ∈ foreground \\ 1 / {( {H}^{′} * {W}^{′} )}^{p} & ( i , j ) ∈ background\end{matrix} ,$$

$${m}_{ij} = {H}^{′} * {W}^{′} * {m}_{ij}^{′} / {\sum }_{i , j} {m}_{ij}^{′} ,$$

c_{i,j} represents an area of a bounding box to which a pixel (i, j) belongs, and p is an adjustable parameter. To improve numerical stability in a fine-tuning process, a reweighted mask m′ is normalized to obtain m. FIG. 7 and FIG. 8 show an example of area reweighting.

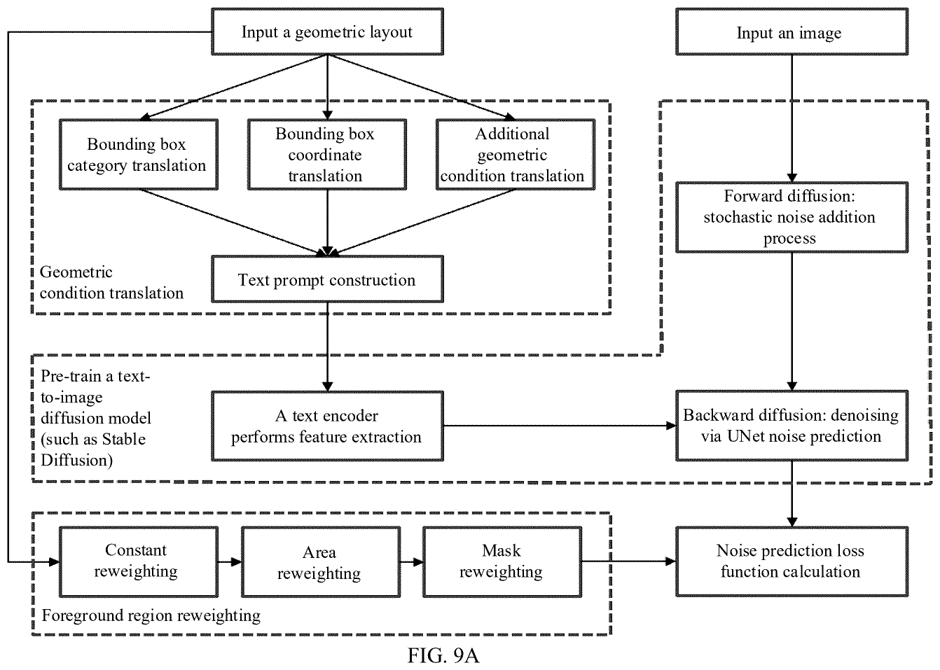

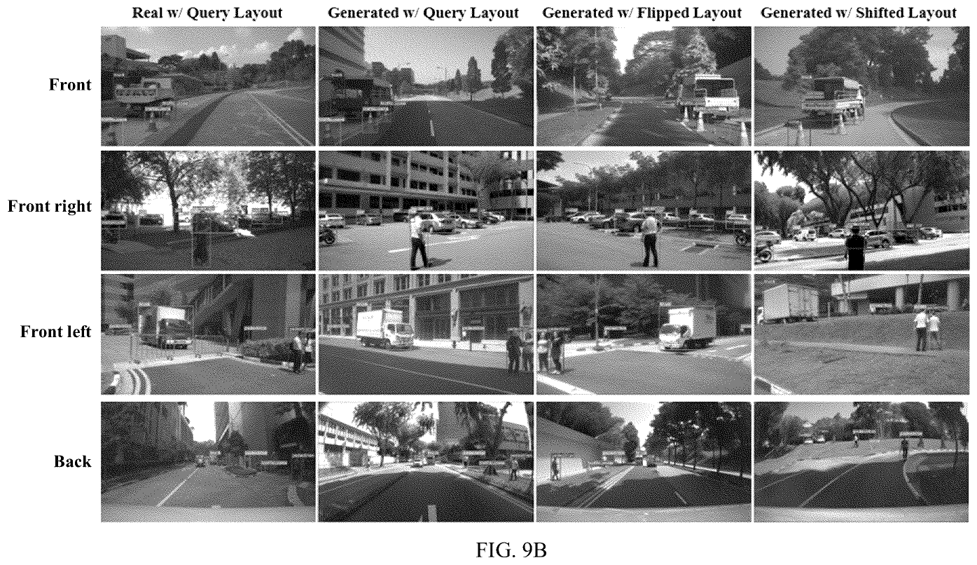

FIG. 9A is a diagram of a specific procedure according to an embodiment of this disclosure.

The following describes beneficial effect in embodiments of this disclosure with reference to an experiment. Training is performed on a public dataset NuImages. With reference to Table 1, embodiments of this disclosure (GeoDiffusion) may obtain a current optimal generation result (including image quality FID and object localization mAP), to prove that GeoDiffusion can generate a highly realistic image while strictly adhering to an input geometric condition.

TABLE 1

| | Input | | | Average Precision↑ | | | | |
|---|---|---|---|---|---|---|---|---|
| Method | Resolution | Epochs | FID↓ | mAP | AP₅₀ | AP₇₅ | AP^{m} | APⁱ |
| Oracle* | — | — | — | 48.2 | 75.0 | 52.0 | 46.7 | 60.5 |
| LostGAN [40] | 256 × 256 | 256 | 59.95 | 4.4 | 9.8 | 3.3 | 2.1 | 12.3 |
| LAMA [24] | 256 × 256 | 256 | 63.85 | 3.2 | 8.3 | 1.9 | 2.0 | 9.4 |
| Taming [22] | 256 × 256 | 256 | 32.84 | 7.4 | 19.0 | 4.8 | 2.8 | 18.8 |
| GeoDiffusion | 256 × 256 | 64 | 15.67 | 15.4 | 29.4 | 14.5 | 9.7 | 36.0 |
| GeoDiffusion | 512 × 512 | 64 | 12.62 | 21.4 | 46.1 | 17.4 | 12.9 | 44.9 |
| GeoDiffusion | 800 × 456 | 64 | 11.99 | 30.1 | 59.2 | 27.6 | 24.0 | 53.2 |

In addition, with reference to FIG. 9B, data generated by an extension model may be used to assist in training an object detection model. GeoDiffusion is used to generate data to enhance a real training dataset. The object detection model can achieve consistent performance improvements across various categories, with especially significant improvements on annotation-scarce long-tail categories (truck & trailer & bus, which only account for 7.2% of annotated data).

TABLE 2

| | | | | | | | | | | traffic | |
|---|---|---|---|---|---|---|---|---|---|---|---|
| Method | mAP | car | truck | trailer | bus | construction | bicycle | motorcycle | pedestrian | cone | barrier |
| Real only | 36.9 | 52.9 | 40.9 | 15.5 | 42.1 | 24.0 | 44.7 | 46.7 | 31.3 | 32.5 | 38.9 |
| LostGAN [40] | 35.6 | 51.7 | 39.6 | 12.9 | 41.3 | 22.7 | 42.4 | 45.6 | 30.0 | 31.6 | 37.9 |
| LAMA [24] | 35.6 | 51.7 | 39.2 | 14.3 | 40.5 | 22.9 | 43.2 | 44.9 | 30.0 | 31.3 | 38.3 |
| Taming [22] | 35.8 | 51.9 | 39.3 | 14.7 | 41.1 | 22.4 | 43.1 | 45.4 | 30.4 | 31.6 | 38.1 |
| GeoDiffusion | 37.4 | 53.0 | 42.4 | 16.5 | 43.5 | 25.7 | 44.8 | 46.7 | 30.6 | 31.7 | 39.2 |

In addition, GeoDiffusion demonstrates an extremely strong generalization capability for scenario layouts that have not been seen, fully meeting requirements of users for simulating new scenarios. GeoDiffusion also demonstrates extremely strong robustness even for rare scenarios outside normal distribution.

A general detection dataset COCO is used as an example. The following operation procedure is performed: A geometric condition (for example, a bounding box) is converted into a text prompt based on a category annotation and the bounding box of an object in a training set, to obtain an image-text pair; the constructed image-text pair is used to fine-tune a pre-trained text-to-image diffusion model, and a foreground reweighting mechanism is performed in a training process, to adaptively allocate a higher loss weight to a foreground region while considering area-difference-based weighting between foreground objects at the same time.

Table 3 shows data generation effect of the COCO dataset.

TABLE 3

| Method | Epoch | FID↓ | mAP↑ | AP₅₀↑ | AP₇₅↑ |
|---|---|---|---|---|---|
| LostGAN [40] | 200 | 42.55 | 9.1 | 15.3 | 9.8 |
| LAMA [24] | 200 | 31.12 | 13.4 | 19.7 | 14.9 |
| CAL2IM [17] | 200 | 29.56 | 10.0 | 14.9 | 11.1 |
| Taming [22] | 68 + 60 | 33.68 | — | — | — |
| TwRA [44] | 300 | 22.15 | — | 28.2 | 20.1 |
| GeoDiffusion | 50 | 19.64 | 26.2 | 39.6 | 29.8 |

In addition, an embodiment of this disclosure further provides a data processing method. Different from the embodiment corresponding to FIG. 5, this embodiment shows a model inference process performed based on a model obtained after training in the embodiment corresponding to FIG. 5. The method may include: obtaining a first image and text information, where the text information indicates a location constraint of at least one object in an image, and the first image is an image obtained by performing noise addition using a noise addition module in a diffusion model; processing the text information based on a text encoder to obtain a first feature representation; and obtaining a second image based on a fusion result of the first image and the first feature representation by using a denoising model in the diffusion model, where an object included in the second image meets the location constraint indicated by the text information.

For specific descriptions of the inference process, refer to the descriptions of the feedforward process in the embodiment corresponding to FIG. 5. Similarities are not described herein again.

In an embodiment, the first image is an image obtained by performing noise addition on an original image using the noise addition module in the diffusion model, the original image includes the at least one object, and the text information specifically includes a size of a detection box corresponding to each object in the original image and a location of the detection box in the original image.

In an embodiment, the text information further includes: a category of image content in the detection box, or camera viewpoint information present when the first image is captured.

In an embodiment, the object is a key point on a person for indicating a pose.

In an embodiment, the fusion result is obtained by performing attention mechanism-based interaction on the first image and the first feature representation.

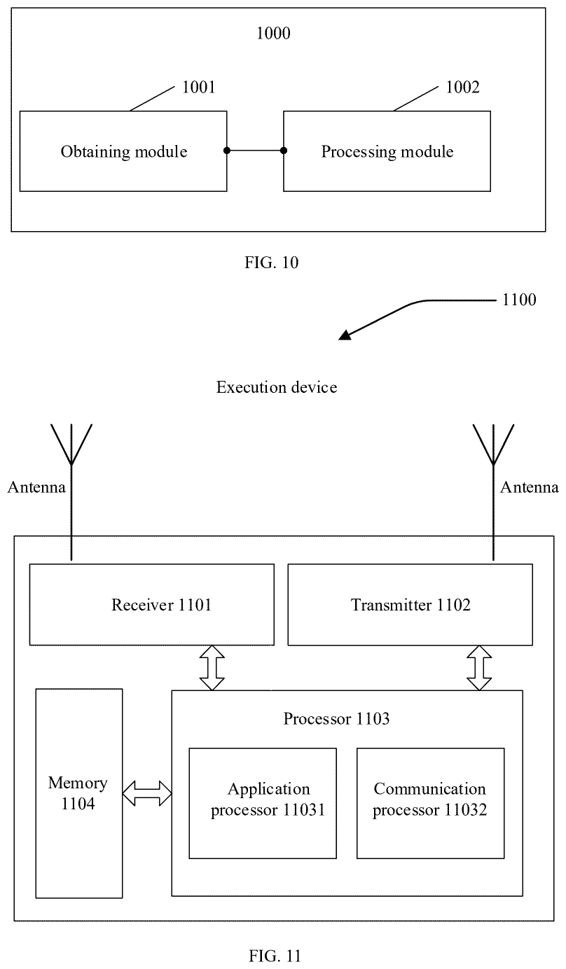

FIG. 10 is a diagram of a structure of a data processing apparatus according to an embodiment of this disclosure. As shown in FIG. 10, the data processing apparatus 1000 provided in this embodiment of this disclosure includes:
an obtaining module 1001, configured to obtain a first image and text information, where the text information indicates a location constraint of at least one object in an image, and the first image is an image obtained by performing noise addition on an original image using a noise addition module in a diffusion model, where
for specific descriptions of the obtaining module 1001, reference may be made to the descriptions of operation 501 in the foregoing embodiment, and this is not described herein again; and
a processing module 1002, configured to: process the text information based on a text encoder to obtain a first feature representation;
obtain a second image based on a fusion result of the first image and the first feature representation using an image generator in the diffusion model; and
determine a loss based on the second image and the original image, and update the text encoder and a denoising model based on the loss, where
for specific descriptions of the processing module 1002, reference may be made to the descriptions of operation 502 to operation 504 in the foregoing embodiment, and this is not described herein again.

In an embodiment, the processing module 1002 is specifically configured to:
determine a first loss based on a foreground region of the second image and a foreground region of the original image;
determine a second loss based on a background region of the second image and a background region of the original image; and
fuse the first loss and the second loss through weighting to obtain the loss, where a weight corresponding to the first loss is greater than a weight corresponding to the second loss.

In an embodiment, the at least one object includes a first object and a second object; the first object is located in a first foreground region in the second image, and the second object is located in a second foreground region in the second image; and the processing module 1002 is specifically configured to:
determine a first sub-loss based on the first foreground region and a foreground region that is in the original image and that corresponds to the first foreground region;
determine a second sub-loss based on the second foreground region and a foreground region that is in the original image and that corresponds to the second foreground region; and
fuse the first sub-loss and the second sub-loss through weighting to obtain the first loss, where the first loss is a part of the loss, an area of the first foreground region is greater than that of the second foreground region, and a weight corresponding to the first sub-loss is less than a weight corresponding to the second foreground region.

In an embodiment, the first image is the image obtained by performing noise addition on the original image using the noise addition module in the diffusion model, the original image includes the at least one object, and the text information specifically includes a size of a detection box corresponding to each object in the original image and a location of the detection box in the original image.

In an embodiment, the text information further includes: a category of image content in the detection box, or camera viewpoint information present when the first image is captured.

In addition, an embodiment of this disclosure further provides a data processing apparatus. The apparatus includes:
an obtaining module, configured to obtain a first image and text information, where the text information indicates a location constraint of at least one object in an image, and the first image is an image obtained by performing noise addition using a noise addition module in a diffusion model; and
a processing module, configured to: process the text information based on a text encoder to obtain a first feature representation; and
obtain a second image based on a fusion result of the first image and the first feature representation by using a denoising model in the diffusion model, where an object included in the second image meets the location constraint indicated by the text information.

In an embodiment, the first image is an image obtained by performing noise addition on an original image using the noise addition module in the diffusion model, the original image includes the at least one object, and the text information specifically includes a size of a detection box corresponding to each object in the original image and a location of the detection box in the original image.

In an embodiment, the text information further includes: a category of image content in the detection box, or camera viewpoint information present when the first image is captured.

In an embodiment, the object is a key point on a person for indicating a pose.

In an embodiment, the fusion result is obtained by performing attention mechanism-based interaction on the first image and the first feature representation.

The following describes an execution device provided in embodiments of this disclosure. FIG. 11 is a diagram of a structure of an execution device according to an embodiment of this disclosure. The execution device 1100 may be specifically represented as a virtual reality VR device, a mobile phone, a tablet, a notebook computer, an intelligent wearable device, a monitoring data processing device, a server, or the like. This is not limited herein. Specifically, the execution device 1100 includes a receiver 1101, a transmitter 1102, a processor 1103, and a memory 1104 (there may be one or more processors 1103 in the execution device 1100, and one processor is used as an example in FIG. 11). The processor 1103 may include an application processor 11031 and a communication processor 11032. In some embodiments of this disclosure, the receiver 1101, the transmitter 1102, the processor 1103, and the memory 1104 may be connected through a bus or in another manner.

The memory 1104 may include a read-only memory and a random access memory, and provide instructions and data for the processor 1103. A part of the memory 1104 may further include a non-volatile random access memory (NVRAM). The memory 1104 stores a processor and operation instructions, an executable module, a data structure, a subset thereof, or an extended set thereof. The operation instructions may include various operation instructions for implementing various operations.

The processor 1103 controls operations of the execution device. During specific application, components of the execution device are coupled together through a bus system. In addition to a data bus, the bus system may further include a power bus, a control bus, a status signal bus, and the like. However, for clear description, various types of buses in the figure are referred to as the bus system.

The method disclosed in embodiments of this disclosure may be applied to the processor 1103 or may be implemented by the processor 1103. The processor 1103 may be an integrated circuit chip and has a signal processing capability. In an embodiment, operations in the method may be implemented by using a hardware integrated logic circuit in the processor 1103, or by using instructions in a form of software. The processor 1103 may be a general-purpose processor, a DSP, a microprocessor, or a microcontroller; or may further include an ASIC, a FPGA or another programmable logic device, a discrete gate or transistor logic device, or a discrete hardware component. The processor 1103 may implement or perform the methods, operations, and logical block diagrams that are disclosed in embodiments of this disclosure. The general-purpose processor may be a microprocessor, or the processor may be any conventional processor or the like. The operations in the method disclosed with reference to embodiments of this disclosure may be directly performed and completed by a hardware decoding processor, or may be performed and completed by using a combination of hardware in the decoding processor and a software module. The software module may be located in a mature storage medium in the art, for example, a random access memory, a flash memory, a read-only memory, a programmable read-only memory, an electrically erasable programmable memory, or a register. The storage medium is located in the memory 1104, and the processor 1103 reads information in the memory 1104 and completes operations related to the model inference process in the method in combination with hardware of the processor.

The receiver 1101 may be configured to: receive input digit or character information, and generate a signal input related to a related setting and function control of the execution device. The transmitter 1102 may be configured to output digit or character information through a first interface. The transmitter 1102 may be further configured to send instructions to a disk group through the first interface, to modify data in the disk group. The transmitter 1102 may further include a display device, for example, a display.

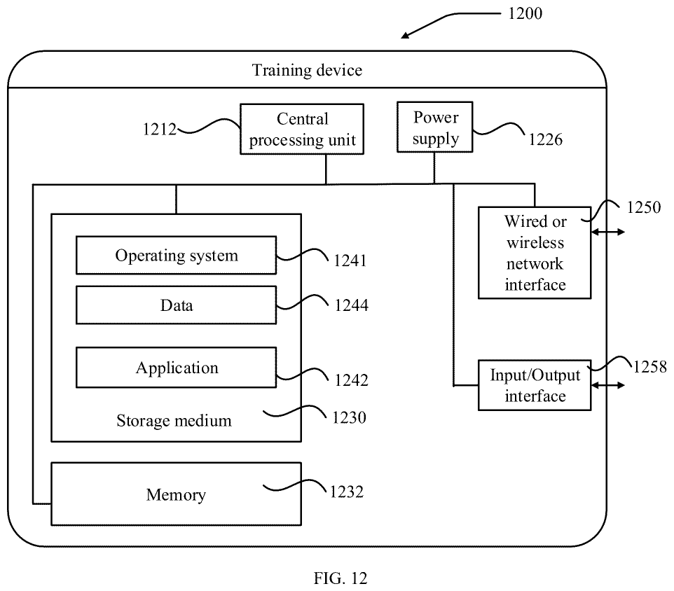

Embodiments of this disclosure further provide a training device. FIG. 12 is a diagram of a structure of a training device according to an embodiment of this disclosure. Specifically, the training device 1200 is implemented by one or more servers, the training device 1200 may vary greatly with different configurations or performance, and may include one or more central processing units (CPUs) 1212 (for example, one or more processors), a memory 1232, and one or more storage media 1230 (for example, one or more mass storage devices) that store an application 1242 or data 1244. The memory 1232 and the storage medium 1230 may be transient storage or persistent storage. The program stored in the storage medium 1230 may include one or more modules (not shown in the figure). Each module may include a series of instruction operations for the training device. Further, the central processing unit 1212 may be configured to communicate with the storage medium 1230, to perform, on the training device 1200, a series of instruction operations in the storage medium 1230.

The training device 1200 may further include one or more power supplies 1226, one or more wired or wireless network interfaces 1250, one or more input/output interfaces 1258, or one or more operating systems 1241, for example, Windows Server™, Mac OS X™, Unix™, Linux™, and FreeBSD™.

In this embodiment of this disclosure, the central processing unit 1212 is configured to perform actions related to model training in the foregoing embodiment.

An embodiment of this disclosure further provides a computer program product. When the computer program product runs on a computer, the computer is caused to perform operations performed by the foregoing execution device, or the computer is caused to perform operations performed by the foregoing training device.

An embodiment of this disclosure further provides a computer-readable storage medium. The computer-readable storage medium stores a program used to process a signal. When the program is run on a computer, the computer is caused to perform operations performed by the foregoing execution device, or the computer is caused to perform operations performed by the foregoing training device.

The execution device, the training device, or a terminal device provided in embodiments of this disclosure may be specifically a chip. The chip includes a processing unit and a communication unit. The processing unit may be, for example, a processor. The communication unit may be, for example, an input/output interface, a pin, or a circuit. The processing unit may execute computer-executable instructions stored in a storage unit, so that a chip in the execution device performs the data processing method described in embodiments, or a chip in the training device performs the data processing method described in embodiments. Optionally, the storage unit is a storage unit in the chip, for example, a register or a buffer; or the storage unit may be a storage unit that is in a radio access device end and that is located outside the chip, for example, a read-only memory (ROM), another type of static storage device that can store static information and instructions, or a random access memory (RAM).

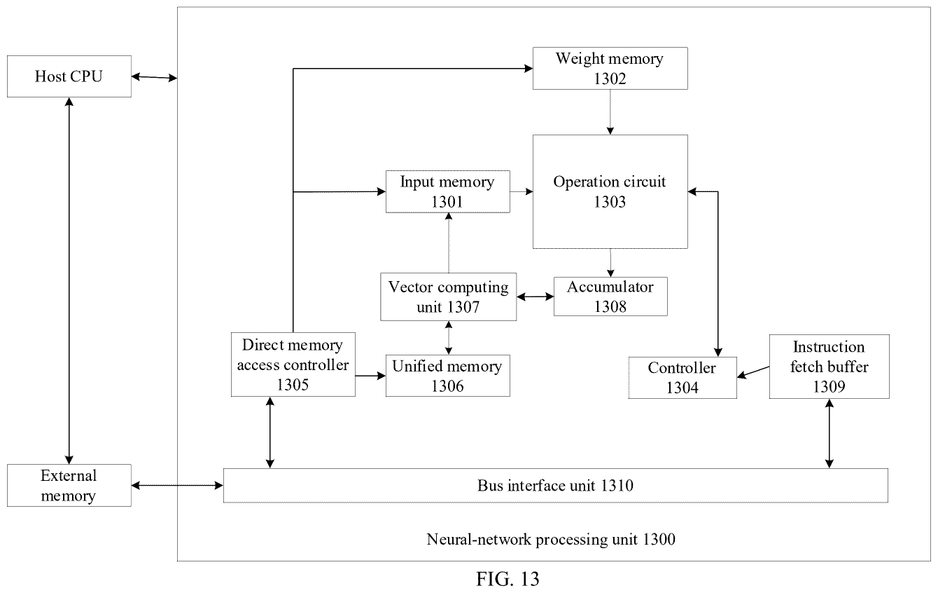

Specifically, FIG. 13 is a diagram of a structure of a chip according to an embodiment of this disclosure. The chip may be represented as a neural-network processing unit NPU 1300. The NPU 1300 is mounted to a host CPU (Host CPU) as a coprocessor, and the host CPU allocates a task to the NPU. A core part of the NPU is an operation circuit 1303. A controller 1304 controls the operation circuit 1303 to extract matrix data in a memory and perform a multiplication operation.

In some embodiments, the operation circuit 1303 includes a plurality of process engines (PEs). In some embodiments, the operation circuit 1303 is a two-dimensional systolic array. The operation circuit 1303 may alternatively be a one-dimensional systolic array or another electronic circuit capable of performing mathematical operations such as multiplication and addition. In some embodiments, the operation circuit 1303 is a general-purpose matrix processor.

For example, it is assumed that there are an input matrix A, a weight matrix B, and an output matrix C. The operation circuit extracts, from the weight memory 1302, data corresponding to the matrix B, and buffers the data on each PE in the operation circuit. The operation circuit fetches data of the matrix A from an input memory 1301, performs a matrix operation on the data and the matrix B, and stores an obtained partial result or final result of the matrix in an accumulator 1308.

A unified memory 1306 is configured to store input data and output data. Weight data is directly transferred to the weight memory 1302 through a direct memory access controller (DMAC) 1305. Input data is also transferred to the unified memory 1306 through the DMAC.

BIU, which is the abbreviation for Bus Interface Unit, that is, a bus interface unit 1310, is configured for interaction between an AXI bus and the DMAC and interaction between the AXI bus and an instruction fetch buffer (IFB) 1309.

The bus interface unit 1310 (BIU for short) is used by the instruction fetch buffer 1309 to obtain an instruction from an external memory, and further used by the direct memory access controller 1305 to obtain original data of the input matrix A or the weight matrix B from the external memory.

The DMAC is mainly configured to transfer input data in the external memory DDR to the unified memory 1306, transfer the weight data to the weight memory 1302, or transfer input data to the input memory 1301.

A vector computing unit 1307 includes a plurality of operation processing units; and if necessary, performs further processing such as vector multiplication, vector addition, an exponential operation, a logarithmic operation, or value comparison on an output of the operation circuit 1303. The vector computing unit 1307 is mainly used for non-convolutional/fully connected layer network computation in a neural network, such as batch normalization, pixel-level summation, and upsampling on a feature map.

In some embodiments, the vector computing unit 1307 can store a processed output vector in the unified memory 1306. For example, the vector computing unit 1307 may apply a linear function or a non-linear function to the output of the operation circuit 1303, for example, perform linear interpolation on a feature map extracted by a convolutional layer, or for another example, use a vector of accumulated values to generate an activation value. In some embodiments, the vector computing unit 1307 generates a normalized value, a value obtained through pixel-level summation, or both a normalized value and a value obtained through pixel-level summation. In some embodiments, the processed output vector can be used as an activation input to the operation circuit 1303, for example, used at a subsequent layer in the neural network.

The instruction fetch buffer 1309 connected to the controller 1304 is configured to store instructions used by the controller 1304.

The unified memory 1306, the input memory 1301, the weight memory 1302, and the instruction fetch buffer 1309 are all on-chip memories. The external memory is private to a hardware architecture of the NPU.

Any one of the processors mentioned above may be a general-purpose central processing unit, a microprocessor, an ASIC, or one or more integrated circuits for controlling program execution.

In addition, it should be noted that the described apparatus embodiments are merely examples. The units described as separate parts may or may not be physically separate, and parts displayed as units may or may not be physical units, may be located in one location, or may be distributed on a plurality of network units. Some or all of the modules may be selected based on actual requirements to achieve the objectives of the solutions of embodiments. In addition, in the accompanying drawings of the apparatus embodiments provided in this disclosure, connection relationships between modules indicate that the modules have communication connections with each other, which may be specifically implemented as one or more communication buses or signal cables.

Based on the descriptions of the foregoing embodiments, a person skilled in the art may clearly understand that this disclosure may be implemented by using software in addition to necessary universal hardware, or certainly by using dedicated hardware, including an application-specific integrated circuit, a dedicated CPU, a dedicated memory, a dedicated component, and the like. Generally, all functions completed by a computer program can be easily implemented by using corresponding hardware, and a specific hardware structure used to implement a same function may be in various forms, for example, in a form of an analog circuit, a digital circuit, or a dedicated circuit. However, in this disclosure, a software program embodiment is a better embodiment in most cases. Based on such an understanding, the technical solutions of this disclosure essentially or the part contributing to the conventional technology may be implemented in a form of a software product. The computer software product is stored in a readable storage medium, for example, a floppy disk, a USB flash drive, a removable hard disk, a ROM, a RAM, a magnetic disk, or an optical disc of a computer, and includes several instructions for instructing a computer device (which may be a personal computer, a training device, a network device, or the like) to perform the method in embodiments of this disclosure.

All or some of the foregoing embodiments may be implemented by using software, hardware, firmware, or any combination thereof. When software is used to implement the embodiments, all or some of the embodiments may be implemented in a form of a computer program product.

The computer program product includes one or more computer instructions. When the computer program instructions are loaded and executed on a computer, the procedure or functions according to embodiments of this disclosure are completely or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, training device, or data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a training device or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

What is claimed is:

1. A data processing method, wherein the method comprises:
obtaining a first image and text information, wherein the text information indicates a location constraint of at least one object in an image, and the first image is an image obtained by performing noise addition using a noise addition process of a diffusion model;
processing the text information based on a text encoder to obtain a first feature representation; and
obtaining a second image based on a fusion result of the first image and the first feature representation by using a denoising model in the diffusion model, wherein an object comprised in the second image meets the location constraint indicated by the text information.

2. The method according to claim 1, wherein the first image is an image obtained by performing noise addition on an original image using the noise addition process of the diffusion model, the original image comprises the at least one object, and the text information comprises a size of a detection box corresponding to each object in the original image and a location of the detection box in the original image.

3. The method according to claim 2, wherein the text information further comprises: a category of image content in the detection box, or camera viewpoint information present when the first image is captured.

4. The method according to claim 1, wherein the object is a key point on a person for indicating a pose.

5. The method according to claim 1, wherein the fusion result is obtained by performing attention mechanism-based interaction on the first image and the first feature representation.

6. A data processing method, wherein the method comprises:
obtaining a first image and text information, wherein the text information indicates a location constraint of at least one object in an image, and the first image is an image obtained by performing noise addition on an original image using a noise addition process of a diffusion model;
processing the text information based on a text encoder to obtain a first feature representation;
obtaining a second image based on a fusion result of the first image and the first feature representation using an image generator in the diffusion model; and
determining a loss based on the second image and the original image, and updating the text encoder and a denoising model based on the loss.

7. The method according to claim 6, wherein the at least one object is located in a foreground region in the second image; and the determining the loss based on the second image and the original image comprises:
determining a first loss based on the foreground region of the second image and a foreground region of the original image;
determining a second loss based on a background region of the second image and a background region of the original image; and
fusing the first loss and the second loss through weighting to obtain the loss, wherein a weight corresponding to the first loss is greater than a weight corresponding to the second loss.

8. The method according to claim 6, wherein the at least one object comprises a first object and a second object; the first object is located in a first foreground region in the second image, and the second object is located in a second foreground region in the second image; and the determining the loss based on the second image and the original image comprises:
determining a first sub-loss based on the first foreground region and a foreground region that is in the original image and that corresponds to the first foreground region;
determining a second sub-loss based on the second foreground region and a foreground region that is in the original image and that corresponds to the second foreground region; and
fusing the first sub-loss and the second sub-loss through weighting to obtain a first loss, wherein the first loss is a part of the loss, an area of the first foreground region is greater than that of the second foreground region, and a weight corresponding to the first sub-loss is less than a weight corresponding to the second foreground region.

9. The method according to claim 6, wherein the first image is the image obtained by performing noise addition on the original image using the noise addition process of the diffusion model, the original image comprises the at least one object, and the text information comprises a size of a detection box corresponding to each object in the original image and a location of the detection box in the original image.

10. The method according to claim 9, wherein the text information further comprises: a category of image content in the detection box, or camera viewpoint information present when the first image is captured.

11. A non-transitory computer storage medium, wherein the computer storage medium stores one or more instructions; and when the instructions are executed by one or more computers, the one or more computers are caused to:
obtain a first image and text information, wherein the text information indicates a location constraint of at least one object in an image, and the first image is an image obtained by performing noise addition using a noise addition process of a diffusion model;
process the text information based on a text encoder to obtain a first feature representation; and
obtain a second image based on a fusion result of the first image and the first feature representation by using a denoising model in the diffusion model, wherein an object comprised in the second image meets the location constraint indicated by the text information.

12. The computer storage medium according to claim 11, wherein the first image is an image obtained by performing noise addition on an original image using the noise addition process of the diffusion model, the original image comprises the at least one object, and the text information comprises a size of a detection box corresponding to each object in the original image and a location of the detection box in the original image.

13. The computer storage medium according to claim 12, wherein the text information further comprises: a category of image content in the detection box, or camera viewpoint information present when the first image is captured.

14. The computer storage medium according to claim 11, wherein the object is a key point on a person for indicating a pose.

15. The computer storage medium according to claim 11, wherein the fusion result is obtained by performing attention mechanism-based interaction on the first image and the first feature representation.

16. An execution apparatus, wherein the execution apparatus comprises at least one memory, and at least one processor, the at least one memory is configured to store a program, when the program are executed by the at least one processor, the at least one processor are enabled to:
obtain a first image and text information, wherein the text information indicates a location constraint of at least one object in an image, and the first image is an image obtained by performing noise addition using a noise addition process of a diffusion model;
process the text information based on a text encoder to obtain a first feature representation; and
obtain a second image based on a fusion result of the first image and the first feature representation by using a denoising model in the diffusion model, wherein an object comprised in the second image meets the location constraint indicated by the text information.

17. The execution apparatus according to claim 16, wherein the first image is an image obtained by performing noise addition on an original image using the noise addition process of the diffusion model, the original image comprises the at least one object, and the text information comprises a size of a detection box corresponding to each object in the original image and a location of the detection box in the original image.

18. The execution apparatus according to claim 17, wherein the text information further comprises: a category of image content in the detection box, or camera viewpoint information present when the first image is captured.

19. The execution apparatus according to claim 16, wherein the object is a key point on a person for indicating a pose.

20. The execution apparatus according to claim 16, wherein the fusion result is obtained by performing attention mechanism-based interaction on the first image and the first feature representation.
